(19) United States
(12) Patent Application Publication
(10) Pub. No.: US 2019/0307278 A1
(43) Pub. Date: Oct. 10, 2019

(54) Method for Delivering Mail, a Mail Delivery System and a Software Product

(71) Applicant: Postlogi AS, Bønes (NO)

(72) Inventor: Tore Henneli, Rådal (NO)

(21) Appl. No.: 16/335,901

(22) PCT Filed: Sep. 20, 2017
(86) PCT No.: PCT/NO2017/050237

§ 371 Date: Mar. 22, 2019

(30) Foreign Application Priority Data
Sep. 23, 2016 (NO) 20161529

(51) Int. Cl. A47G 29/14; A47G 29/16; E05B 47/00

(52) U.S. Cl. CPC A47G 29/141; A47G 29/16; E05B 2047/0058; A47G 2029/145; E05B 47/0001

(57) ABSTRACT

Item delivery system comprises at least one personal mailbox and optionally a publicly available post box. The mailbox doors are provided with an electronic lock operated by a radio frequent signal containing an authentication code, sent from a nearby personal communication device provided with software. The software contains modules for performing online payment for mail delivery services and modules for granting or revoking access to mailboxes.

### BACKGROUND

The disclosed embodiments relate to an item delivery system, arranged to receive and optionally deliver items to and from an end user, particularly for delivering and fetching mail items, and a software product.

Mailboxes are used for delivery of mail in different environments and for different users. Clusters of mailboxes may be arranged in suburban areas and in housings, as well as in post offices and on other places with post boxes for rent. Traditionally, each subscriber has an individual key and the personnel delivering the mail have a key for serving several boxes when delivering.

The volume of letters and subscription matters, like magazines, has been reduced, while the volume of packets has increased, partly due to the growth of Internet based shopping. During daytime, packet delivery may be problematic when the recipients usually are out of house and nobody is available for receiving packets which are too large to be placed in an original mailbox.

Moreover, theft from mailboxes is a growing problem in several countries. Bank cards, ID-carrying mail, personal information, and small packets are sought by criminals. Currently available mailboxes do not provide the desirable security against such abuse.

Another weakness of most prior art mailboxes and item delivery systems is the lack of communication on the presence of mail or packets in the mailbox. A rather complex device for detecting and signaling presence of mail items in a mailbox is disclosed in NO 309073 B1, comprising a printed circuit board, electronic components, a light emitter and a light receiver arranged at the bottom of the mailbox.

NO 334687 B1 and the related WO 2013/169114 A1, by the same inventor and applicant as the present, discloses a post delivery system comprising a modular mailbox stand with numerous mailboxes. The respective mailbox is provided with a battery-driven electronic lock which can be operated remotely by a short-distance communication device. The modular mailbox stand is provided with network connection means, A back-end system keeps information about receivers and is arranged to generate permanent and temporary unique mailbox codes for opening individual mailboxes.

### SUMMARY OF THE INVENTION

The disclosed embodiments provide for improvement to the modular mailbox system described above by adding functionality and implementing the mailbox system functionality in one or more software products. Also provided are software products that are executable on regular smartphones and other common hand-held electronic devices. Also provided is a method for fetching and delivering mail items from/to such a mailbox system, and a method for returning mail from a publicly available post box.

A first embodiment provides an item delivery system, arranged to receive and optionally deliver physical items, such as mail and packages, to and from an end user, particularly a modular mailbox assembly having one or more personal mailboxes, and optionally one or more publicly available post boxes arranged to accommodate larger mail items. The personal mailbox and post box are provided with a door, optionally provided with a slot, and are further each provided with an electronic lock which can be activated wirelessly by receiving a radio frequent signal containing a communication protocol having a unique authentication code. The radio-frequent signal is sent from either a short-range end user communication device, or a courier communication device. The respective personal mailboxes are provided with a unique authentication code which can be verified by a remote back-end information system by wireless communication. The publicly available post box is in a similar manner are arranged to receive a temporary authentication code from the short-range courier communication device and store the code in the lock for later authentication the end user attempting to open the lock of the post box by sending a radio frequent signal from the end user's communication device including the temporary authentication code. The mail receiver communication device and the courier communication device are a handheld device selected from the group consisting of a smartphone, personal digital assistant (PDA) and tablet provided with a mail receiver software product, arranged to operate a radio frequent signal emitter in the respective communication devices to activate the lock in the respective mail boxes or post boxes, without need for online communication. The electronic lock and the radio frequent signal emitter can be driven by a battery and/or a solar cell device. Therefore, there is no need for any external power supply, and the item delivery system disclosed herein can be located practically anywhere. However, this fact does not exclude power supply from a power grid either.

The software for the mail receiver communication device further comprises a component arranged to grant or remove courier access to the mail receiver's personal mail box by Internet communication with the back-end information system.

Moreover, the software for the mail receiver communication device further comprises a component or module, arranged to perform online payment of mail delivery services. This functionality simplifies mail return significantly.

The software for the mail receiver communication device may further comprise a component arranged to grant or revoke access to additional persons to the personal mailbox, such as family members or neighbors that can access the mailbox in absence of the owner. The software can also keep track of occupied and available mailboxes and allocate an available mailbox to a particular customer/receiver.

In an advantageous embodiment, the respective mailboxes exhibit a sensor means arranged to detect presence or absence of mail item within the mailbox and/or post box, in communication with a radio frequent signal emitter in the mailbox and/or post box, arranged to emit a signal to an adjacent communication device.

In a preferred embodiment, the radio frequent signal emitter is a near-field communication means (NFC means) or a Bluetooth communication means in a commercially available smartphone or similar personal communication device. The combination of NFC and Bluetooth enables the disclosed system to be controlled by any type of smart phone and similar devices known today.

An embodiment is related to an item delivery system, particularly mail or parcel items, arranged to receive and optionally deliver items to and from an end user. The system comprises a modular mailbox assembly having one or more personal mailboxes, and optionally one or more publicly available post boxes, arranged to accommodate larger mail items. The mailbox and post box exhibit a door, optionally provided with a slot, and is further provided with an electronic lock which can be activated wirelessly by receiving a radio frequent signal, including a communication protocol containing a unique authentication code, sent from either a short-range end user communication device, or a courier communication device, wherein the respective personal mailboxes are provided with a unique authentication code which can be verified by a remote back-end information system by wireless communication. The respective post boxes are in a similar manner arranged to receive a temporary authentication code from the short-range courier communication device and to be opened by a radio frequent signal sent from either the mail receiver communication device or the courier communication device.

The respective mail receiver communication device and the courier communication device is a handheld device selected from the group consisting of a smartphone, personal digital assistant (PDA) and tablet provided with a software product, arranged to operate a radio frequent signal sender and receiver in the form of a near-field communication means (NFC means) or a Bluetooth communication means, arranged within the respective communication devices, to activate the lock in the respective mail boxes or post boxes without need for online communication, wherein the back-end communication system is arranged to communicate with back-end communication systems operated by a courier company, and wherein the electronic lock and the radio frequent signal emitter are driven by a battery and/or a solar cell device.

In one embodiment, the software for the mail receiver communication device (20) further comprises a component arranged to grant or remove courier access to the mail receiver's personal mail box by Internet communication with the back-end information system.

In another embodiment, the software for the mail receiver communication device further comprises a component arranged to perform online payment of mail delivery services.

Moreover, the software for the mail receiver communication device can further comprise a component arranged to grant or revoke access to additional persons to the personal mailbox.

In a preferred embodiment, the respective mailboxes exhibit a sensor means arranged to detect presence or absence of mail item within the mailbox and/or publicly available post box, in communication with a radio frequent signal emitter in the mailbox and/or publicly available post box, arranged to emit a signal to an adjacent communication device.

Another embodiment is related to a method of sending mail or performing mail return by an end user, by using a publicly available post box in an item delivery system as described above.

The method comprises the steps of:

a) providing an end user communication device exhibiting a radio frequent signal emitter means,

b) providing a publicly available post box, particularly arranged to accommodate relatively larger mail items, said publicly available post box exhibiting a radio frequent signal emitter and receiver means,

c) installing mail receiver software on the end user communication device,

d) optionally executing a function in mail receiver software installed in the end user communication device and performing payment for the mail return to a back-end information system or directly to a service provider,

e) by the back-end information system, providing a unique temporary authentication code for the publicly available post box and storing the authentication code in the end user communication device,

f) by the end user, positioning the end user communication device in the vicinity of the publicly available post box,

g) by the end user communication device, executing a function in the mail receiver software and sending the authentication code to the publicly available post box by the radio frequent signal emitter means to open the lock and hence the door,

h) by the end user, depositing one or more mail items to be returned or sent in the publicly available post box,

i) by the end user communication device or publicly available post box, notifying the back-end information system that mail is available in the publicly available post box,

j) by the back-end information system, notifying mail service provider that mail is available to be picked up,

k) by a courier, positioning the courier communication device in the vicinity of the post box,

l) executing a function in the courier software, sending a radio frequent signal from the courier communication device to the publicly available post box and opening the lock and hence the door of the publicly available post box, and

m) by the courier, retrieving said one or more mail items from the publicly available post box,

Yet another embodiment is related to a method of performing mail delivery to, and fetching mail from, a publicly available post box by a courier and mail receiver, respectively, in an item delivery system as described above, wherein the method comprises the steps of:

a) providing a courier communication device exhibiting a radio frequent signal sender means,

b) providing a publicly available post box arranged to accommodate mail items, particularly relatively larger mail items; exhibiting a radio frequent signal sender and receiver means,

c) installing mail delivery software on the courier communication device,

d) providing a unique temporary authentication code for the publicly available post box,

e) by the courier, positioning the courier communication device in the vicinity of the publicly available post box,

f) executing a function in the mail delivery software and sending the code to the publicly available post box by the radio frequent signal sender means and storing the authentication code in the publicly available post box,

g) executing a function in the mail delivery software and opening the lock and hence the door of the publicly available post box, and by the courier, depositing one or more mail items in the publicly available post box,

h) by the courier and courier communication device, notifying the back-end system that mail is available in the publicly available post box,

i) by the back-end system, notifying mail receiver that mail is available and providing the mail receiver communication device with the temporary authentication code,

j) by the mail receiver, positioning the mail receiver communication device in the vicinity of the publicly available post box, and

k) executing a function in the mail receiver software, sending a radio frequent signal to the post box and opening the lock and hence the door of the post box, and retrieving mail items from the post box.

In one embodiment of the method described immediately above, the mail receiver before step k) executes a payment function in the mail receiver software to perform payment of mail service consumed before opening the lock.

Yet another embodiment is related to a method of delivering mail to, and fetching mail from, a personal mailbox in an item delivery system as described above, wherein the method comprises the steps of:

a) providing a hand-held mail receiver communication device and a hand-held courier communication device, both exhibiting a radio frequent signal emitter and receiver means,

b) providing a personal mail box including an electronic lock, and a radio frequent signal emitter and receiver means and a unique authentication code,

c) installing mail delivery mail receiver software on the mail receiver communication device and installing mail delivery courier software on the courier communication device,

d) executing a function in the mail delivery courier software to verify that radio frequent signal emitter means is activated in the courier communication device, and optionally activating the radio frequent signal emitter means in the courier communication device,

e) by a courier, positioning the courier communication device in the vicinity of the personal mailbox,

f) executing a function in the mail delivery courier software and sending the unique authentication code or a master key to the personal mailbox to open the mailbox lock and hence the door of the personal mailbox,

g) by the courier, depositing one or more mail items in the personal mailbox,

h) notifying a back-end system that mail has been delivered to the personal mailbox in question,

i) by the back-end system, notifying a mail receiver that mail is present in the personal mailbox by sending a message by Internet,

j) executing a function in the mail receiver software to verify that radio frequent signal emitter means is activated in the mail receiver communication device, and optionally activating the radio frequent signal emitter means in the mail receiver communication device,

k) by the mail receiver, positioning the mail receiver communication device in the vicinity of the personal mailbox,

l) executing a function in the mail receiver software and sending the unique authentication code to the personal mailbox to open the mailbox lock and hence the door of the personal mailbox, and

m) by the mail receiver, retrieving one or more mail items from the personal mailbox.

In one embodiment of the method above, the mail receiver before step l) can execute a payment function in the mail receiver software to perform payment of mail service consumed before opening the lock.

In another embodiment, the user can execute a function in the mail receiver software to grant or revoke courier access to the personal mailbox by notifying the back-end information system by Internet.

The back-end communication system is advantageously arranged to communicate with back-end communication systems operated by courier companies, or mail delivery service providers.

Also disclosed herein is a software product with algorithms arranged to resemble the steps of the method steps set forth above.

### BRIEF DESCRIPTION OF THE DRAWINGS

The invention is now illustrated in further detail by means of drawings, where

FIG. 1 is a schematic illustration of some of the components and collaborators in the system,

FIG. 2 is a perspective view of a mailbox,

FIG. 3 is a sectional view of a mailbox lock, and

FIG. 4 is another embodiment of the lock.

### DETAILED DESCRIPTION

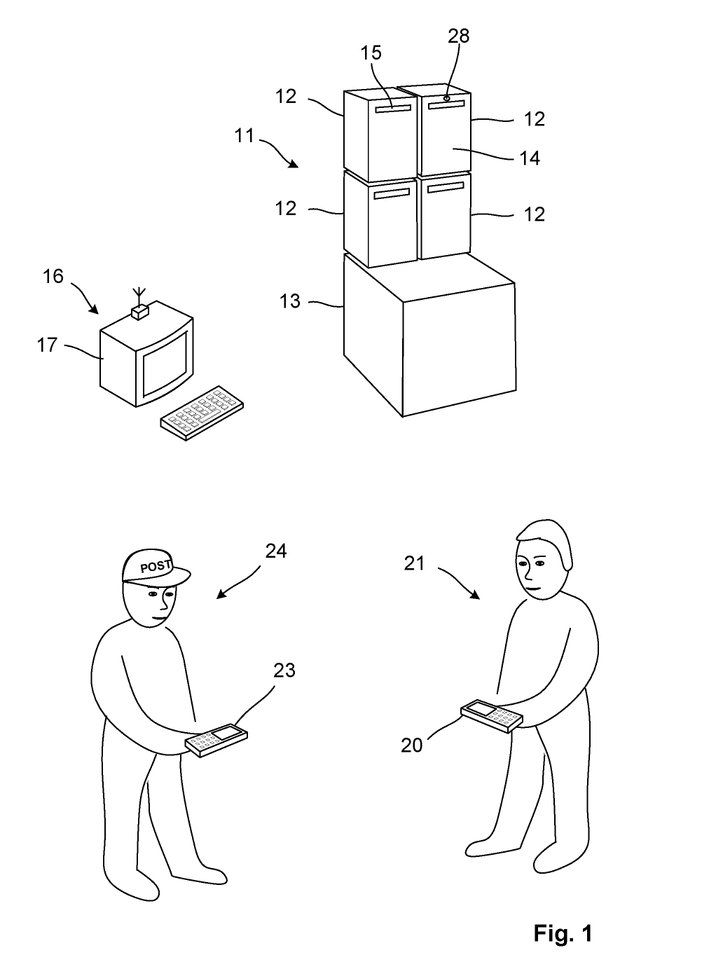

Reference is now made to FIGS. 1-3. These drawings are in part consistent with drawings in the applicant's earlier application WO 2013/169114 A1 and are not described in full detail here. FIG. 1 shows two of the collaborators, the courier 24 and the mail receiver or end user 21. The courier 23 is provided with a smartphone 23 with NFC means and optionally Bluetooth means. Similarly, the end user 21 is provided with a smartphone 20 with NFC means and optionally Bluetooth means, A third collaborator, a back-end information system 16, is arranged to generate authentication codes, to store information about customers and service providers, and means for receiving and sending messages by Internet between courier and end user. The system also includes another collaborator, the service providers. The service providers are preferably integrated in the system, where the end users can grant or revoke access to their personal mailbox, and where all collaborators can exchange messages by Internet.

The back-end information systems is arranged to handle all logic regarding distribution of authentication codes and updates regarding permissions and post item flow, and keeps information about users, vendors and deliveries in databases.

FIG. 1 illustrates an item delivery system 11, e.g. for housing cooperative, with numerous personal mailboxes 12 and a publicly available post box 13. The respective mailbox exhibits a door 14, optionally with a slot 15 and an indicator 28. The item delivery system 11 is advantageously not provided with any Internet connection or power supply.

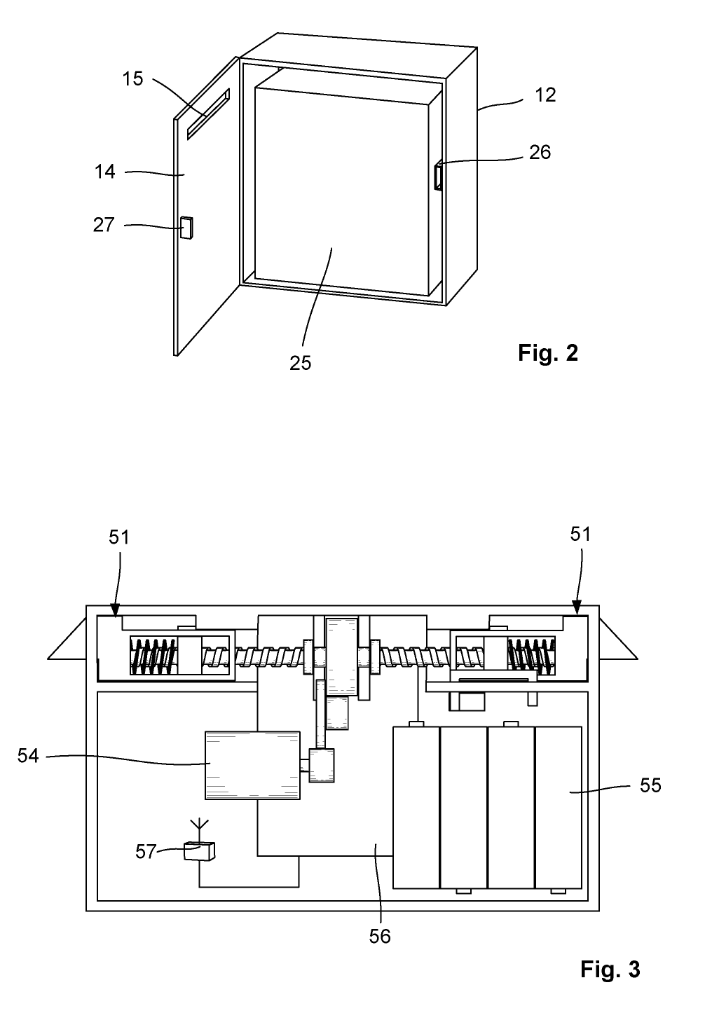

FIG. 2 shows a personal mail box 12 with a door, 14, a slot 15 and an electrical lock 26, 27. A section of an embodiment of a possible lock is illustrated in FIG. 3 by locking elements 51 operated by a motor 54 and batteries. Moreover, the lock is provided with an electronic circuit board 56 and a short range radio frequent communication means 57.

Moreover, the communication devices 20 and 23 are arranged to exchange authentication codes, directly with the mail box 12 and post box 13 by means of their radio frequent communication means. The mail boxes 12 and post box 13 are arranged to store temporary or permanent authentication codes and to send messages by their radio frequent communication means the communication devices 20 and 23.

In a preferred embodiment, the communication devices 20 and 23 are regular smartphones or similar, provided with software arranged to operate the NFC and Bluetooth means in the smartphone that enables exchange of authentication codes between the communication devices and the mailboxes or post box and to operate their electronic lock, without accessing Internet or the telephone network. The mail box system 11 does not need to be connected to any power supply or communication network, and is solely powered by batteries or solar cells.

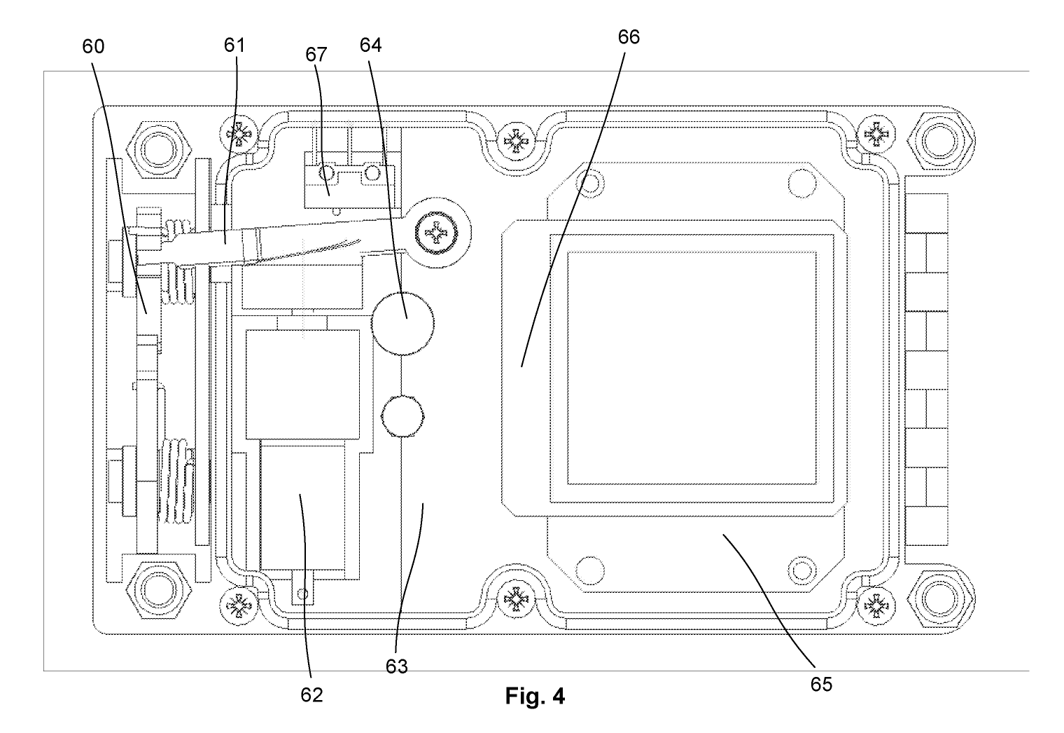

FIG. 4 illustrates another embodiment of a lock for use with the disclosed embodiments. The lock comprises a housing accommodating a latch 60, preferably of steel, connected to a release arm 61 driven by a motor 62 powered by a battery supply 63, arranged to operate the latch 60 between a locked and unlocked position via a switch 67. The radio frequent communication means is implemented in the form of an antenna 66 operated by a NFC/Bluetooth controller card 65. The lock is also provided with a power backup 64 in case of battery failure. This arrangement provides a very compact and energy efficient lock that provides secure and long lasting service.

Modifications

Whereas the delivery system has been illustrated by an item delivery system, the system according to the and the accompanying method and software product of the disclosure is applicable to delivery or exchange of any physical items, not limited to mail items only.

1-12. (canceled)

13. An item delivery system, arranged to receive and optionally deliver items to and from an end user via a modular mailbox assembly (11) having one or more personal mailboxes (12), and optionally one or more publicly available post boxes (13), each of said one or more mailboxes (12) and one or more post boxes (13), if present, having a door (14) and further provided with an electronic lock (26) which can be activated wirelessly by receiving a radio frequent signal, including a communication protocol containing a unique authentication code, sent from either a short-range mail receiver communication device (20), or a courier communication device (23), wherein
the respective one or more personal mailboxes (12) are assigned a unique authentication code which can be verified by a remote back-end information system (16) by wireless communication,
the respective one or more post boxes (13), if present, are arranged to receive a temporary authentication code from the short-range courier communication device (23) and to be opened by a radio frequent signal sent from either the mail receiver communication device (20) or the courier communication device (23),
the respective mail receiver communication device (20) and the courier communication device (23) is a handheld device selected from the group consisting of a smartphone, personal digital assistant (PDA) and tablet provided with a software product, the handheld device configured to operate a radio frequent signal sender and receiver in the form of a near-field communication means (NFC means) or a Bluetooth communication means arranged within the respective mail receiver communication device (20) or courier communication device (23), to activate the lock (26) in the respective one or more mail boxes (12) and one or more post boxes (13), if present, without need for online communication, and
the back-end communication system (16) is arranged to communicate with back-end communication systems operated by a courier company, and wherein the electronic lock (26) and the radio frequent signal emitter are driven by one or more of a battery and a solar cell device.

14. The system of claim 13, wherein said software for the mail receiver communication device (20) further comprises a component arranged to grant or remove courier access to the mail receiver's personal mail box (12) by Internet communication with the back-end information system (16).

15. The system of claim 13, wherein said software for the mail receiver communication device (20) further comprising a component arranged to perform online payment of mail delivery services.

16. The system of claim 13, wherein said software for the mail receiver communication device (20) further comprises a component arranged to grant or revoke access to additional persons to the personal mailbox (12).

17. The system of claim 13, wherein the respective one or more mail boxes (12) and one or more post boxes (13), if present, include a sensor arranged to detect presence or absence of a mail item within the respective one or more mail boxes (12) and one or more post boxes (13), if present, in communication with a radio frequent signal emitter in the respective one or more mail boxes (12) and one or more post boxes (13), if present, arranged to emit a signal to an adjacent mail receiver communication device (20) or courier communication device (23).

18. A method of sending or returning mail by an end user (21), by using a publicly available post box (13) in an item delivery system according to claim 13, comprising the steps of:
n) providing a mail receiver communication device (20) exhibiting a radio frequent signal emitter means,
o) providing a publicly available post box (13) exhibiting a radio frequent signal emitter and receiver means,
p) installing mail receiver software on the mail receiver communication device (20),
q) optionally executing a function in mail receiver software installed in the mail receiver communication device (20) and performing payment for the mail return to a back-end information system (16) or directly to a service provider,
r) providing a unique temporary authentication code for the publicly available post box (13) via the back-end information system (16), and storing the authentication code in the mail receiver communication device (20),
s) positioning the mail receiver communication device (20) in the vicinity of the publicly available post box (13),
t) executing a function in the mail receiver software and sending the authentication code to the publicly available post box (13) by the radio frequent signal emitter means to open the lock (26) and hence the door (14),
u) depositing one or more mail items to be returned or sent in the publicly available post box (13),
v) notifying the back-end information system (16) that mail is available in the publicly available post box (13) via the end user communication device (20) or publicly available post box (13),
w) notifying mail service provider that mail is available to be picked up via the back-end information system (16),
x) positioning the courier communication device (23) in the vicinity of the post box (13),
y) executing a function in the courier software, sending a radio frequent signal from the courier communication device (23) to the publicly available post box (13) and opening the lock (26) and hence the door (14) of the publicly available post box (13), and
z) retrieving said one or more mail items from the publicly available post box (13).

19. A method of performing mail delivery to, and fetching mail from, a publicly available post box (13) by a courier (24) and mail receiver (21), respectively, in an item delivery system according to claim 13, comprising the steps of:
l) providing a courier communication device (23) exhibiting a radio frequent signal sender means,
m) providing a publicly available post box (13) arranged to accommodate mail items and having a radio frequent signal sender and receiver means,
n) installing mail delivery software on the courier communication device (23),
o) providing a unique temporary authentication code for the publicly available post box (13),
p) positioning the courier communication device (23) in the vicinity of the publicly available post box (13),
q) executing a function in the mail delivery software and sending a code to the publicly available post box (13) by the radio frequent signal sender means and storing the authentication code in the publicly available post box (13),
r) executing a function in the mail delivery software and opening the lock (26) and door (14) of the publicly available post box (13), and depositing one or more mail items in the publicly available post box (13),
s) using the courier communication device (23) to notify the back-end system (16) that mail is available in the publicly available post box (13),
t) notifying mail receiver (21) that mail is available and providing the mail receiver communication device (20) with the temporary authentication code by the back-end system (16),
u) positioning the mail receiver communication device (20) in the vicinity of the publicly available post box (13), and
v) executing a function in the mail receiver software, sending a radio frequent signal to the post box (13) and opening the lock (26) and door (14) of the post box (13), and retrieving mail items from the post box (13).

20. The method of claim 19, comprising the step of executing a payment function in the mail receiver software to perform payment of mail service consumed before opening the lock (26) before step (k).

21. The system of claim 14, wherein said software for the mail receiver communication device (20) further comprising a component arranged to perform online payment of mail delivery services.

22. The system of claim 14, wherein said software for the mail receiver communication device (20) further comprises a component arranged to grant or revoke access to additional persons to the personal mailbox (12).

23. The system of claim 14, wherein the respective one or more mail boxes (12) and one or more post boxes (13), if present, include a sensor arranged to detect presence or absence of a mail item within the respective one or more mail boxes (12) and one or more post boxes (13), if present, in communication with a radio frequent signal emitter in the respective one or more mail boxes (12) and one or more post boxes (13), if present, arranged to emit a signal to an adjacent mail receiver communication device (20) or courier communication device (23).

24. The system of claim 15, wherein said software for the mail receiver communication device (20) further comprises a component arranged to grant or revoke access to additional persons to the personal mailbox (12).

25. The system of claim 15, wherein the respective one or more mail boxes (12) and one or more post boxes (13), if present, include a sensor arranged to detect presence or absence of a mail item within the respective one or more mail boxes (12) and one or more post boxes (13), if present, in communication with a radio frequent signal emitter in the respective one or more mail boxes (12) and one or more post boxes (13), if present, arranged to emit a signal to an adjacent mail receiver communication device (20) or courier communication device (23).

26. The system of claim 16, wherein the respective one or more mail boxes (12) and one or more post boxes (13), if present, include a sensor arranged to detect presence or absence of a mail item within the respective one or more mail boxes (12) and one or more post boxes (13), if present, in communication with a radio frequent signal emitter in the respective one or more mail boxes (12) and one or more post boxes (13), if present, arranged to emit a signal to an adjacent mail receiver communication device (20) or courier communication device (23).
